(19) United States
(12) Patent Application Publication
(10) Pub. No.: US 2025/0202370 A1
(43) Pub. Date: Jun. 19, 2025

(54) High-Power DC/DC Converter

(71) Applicant: Siemens Aktiengesellschaft, München (DE)

(72) Inventors: Siegmar Unterweger, München (DE); Martin Schulz, München (DE)

(73) Assignee: Siemens Aktiengesellschaft, München (DE)

(21) Appl. No.: 18/848,821

(22) PCT Filed: Jan. 30, 2023
(86) PCT No.: PCT/EP2023/052126

§ 371 Date: Sep. 19, 2024

(30) Foreign Application Priority Data
Mar. 21, 2022 (DE) 10 2022 202 750.7

(51) Int. Cl. H02M 3/335; H02M 1/00; H02M 1/32; H02M 1/34; H02M 3/00

(52) U.S. Cl. CPC H02M 3/33573; H02M 1/0043; H02M 1/327; H02M 1/342; H02M 3/01

(57) ABSTRACT

Various embodiments of the teachings herein include a DC/DC converter comprising: four power switches forming a full bridge; a resonant coil forming a series circuit with a primary side of a transformer, the series circuit connected between midpoints of two half-bridges of the full bridge; a bridge rectifier connected to a secondary side of the transformer; a control device for the four power switches; an overvoltage protection circuit connected in parallel with an output of the bridge rectifier, the overvoltage protection circuit comprising a capacitor and a fifth power switch connected in series; and a sixth power switch connected in parallel with the output of the bridge rectifier and in series with the fifth power switch.

### CROSS-REFERENCE TO RELATED APPLICATIONS

This application is a U.S. National Stage Application of International Application No. PCT/EP2023/052126 filed Jan. 30, 2023, which designates the United States of America, and claims priority to DE Application No. 10 2022 202 750.7 filed Mar. 21, 2022, the contents of which are hereby incorporated by reference in their entirety.

### TECHNICAL FIELD

The present disclosure relates to electric components. Various embodiments of the teachings herein include DC/DC converters of the phase-shift type with active overvoltage protection.

### BACKGROUND

To limit overvoltages, a so-called clamping circuit is used in DC/DC converters of the phase-shift full-bridge (PSFB) type. For higher-power converters (more than 25 KW), said circuit is typically implemented in an active form (active clamping), i.e. using a power semiconductor. The additional heat introduced by the losses therefrom now needs to be dissipated, as does that from the other power semiconductors. For design reasons, this is generally accomplished using the same type of cooling (heat sink) as is also employed for the rest of the power semiconductors.

As in most power converters for high powers, power modules are typically employed in PSFB DC/DC converters too. These contain two or more power semiconductors. The use of single power semiconductors is uncommon, on the other hand. The points mentioned thus result in a power module containing two power semiconductors being employed for active clamping, even though only one power semiconductor is needed. The two power semiconductors in a module are often connected up, for example as a half-bridge circuit, in such a way that direct parallel connection of the two power semiconductors is not possible.

Producing specialized power modules is economical only for applications with large numbers of items. It must therefore unfortunately be accepted that the switch is not used. The use of a single power switch instead of the power module is very unappealing, as both integration into the cooling system of the power modules and the provision of separate cooling are very complex.

### SUMMARY

Teachings of the present disclosure include DC/DC converters of the phase-shift type that overcome the disadvantages mentioned. For example, some embodiments include a DC/DC converter (10) of the phase-shift type, comprising: a first to a fourth power switch (11 . . . 14), which form a full bridge (110), a resonant coil (19), which forms a series circuit with the primary side (21) of a transformer (20), the series circuit being connected between the midpoints (17, 18) of the half-bridges of the full bridge (110), a bridge rectifier (23) connected to the secondary side (22) of the transformer (20), a control device for the power switches (11 . . . 14, 31, 34) of the DC/DC converter (10), an overvoltage protection circuit (30) connected in parallel with the output of the bridge rectifier (23), the overvoltage protection circuit (30) comprising a series circuit containing a capacitor (32) and a fifth power switch (31), and a sixth power switch (34) connected in parallel with the output of the bridge rectifier (23), the fifth and sixth power switches (31, 34) being connected in series in the same sense and being jointly designed as a power module.

In some embodiments, the control device is configured to operate the first to fourth power switches (11 . . . 14) in the style of a phase-shift converter by allowing a period of time that acts as a phase shift (150) to elapse between the switching times of the power switches (11, 12) of the first half-bridge of the full bridge (110) and the switching times of the power switches (13, 14) of the second half-bridge of the full bridge (110) and, for at least some of the switching cycles, selecting the period of time such that both upper power switches (11, 13) of the full bridge (110) are on together for a length of time.

In some embodiments, the control device is configured to switch off the sixth power switch (34) if a voltage is present on the transformer (20) and to switch on the sixth power switch (34) if no voltage is present on the transformer (20).

In some embodiments, the DC/DC converter (10) includes a common heat sink for the power modules that encompass the first to sixth power switches (11 . . . 14, 31, 34).

In some embodiments, the current carrying capacity of the power switches (11 . . . 14, 31, 34) is at least 100 A and/or in which the reverse withstand voltage of the power switches is at least 100 V.

### BRIEF DESCRIPTION OF THE DRAWINGS

The teachings of the present disclosure are described and explained in more detail hereinbelow on the basis of the exemplary embodiments depicted in the figures, in which:

FIG. 1 shows a circuit diagram of a phase-shift DC/DC converter containing MOSFETs as power switches incorporating teachings of the present disclosure; and

FIG. 2 shows switching responses of the MOSFETs of the phase-shift DC/DC converter.

### DETAILED DESCRIPTION

Some embodiments of the teachings herein include a DC/DC converter of the phase-shift type with a first to a fourth power switch, which together form a full bridge, and a resonant coil, which forms a series circuit with the primary side of a transformer, the series circuit connected between the midpoints of the half-bridges of the full bridge. Furthermore, the DC/DC converter comprises a bridge rectifier connected to the secondary side of the transformer. The bridge rectifier expediently encompasses four diodes that are interconnected in the style of a full bridge.

Furthermore, the DC/DC converter encompasses an overvoltage protection circuit connected in parallel with the output of the bridge rectifier, the overvoltage protection circuit comprising a series circuit containing a capacitor and a fifth power switch. Connected in parallel with the output of the bridge rectifier is, furthermore, a sixth power switch, the fifth and sixth power switches being connected in series in the same sense and being jointly designed as a power module. Finally, the DC/DC converter encompasses a control device for the power switches that are present.

A power module containing two power switches connected up in a half-bridge configuration can be used for the fifth and sixth power switches for the design of the DC/DC converter and is also used fully in that case. Connection in a half-bridge configuration is the most frequent type of connection of two power switches in a power module, resulting in a high level of availability and diversity for ideal matching to the specification of the DC/DC converter.

While the fifth power switch is used for overvoltage protection, the sixth power switch is connected up such that the rectifier diodes can thus be relieved of load in certain operating states in which it is switched on. This results in the overall achievement of improved utilization of the components present given the simplest possible manufacture using available parts.

In some embodiments, the control device may be configured to operate the first to fourth power switches in the style of a phase-shift converter. This involves a period of time that acts as a phase shift being introduced between the switching times of the power switches of the first half-bridge of the full bridge and the switching times of the power switches of the second half-bridge of the full bridge. This period of time leads to the diagonally disposed power switches of the full bridge switching on and off no longer substantially at the same time, but rather with a distinct stagger, depending on the operating situation. This stagger or phase shift may be so distinct that the two upper power switches of the full bridge or the two lower power switches of the full bridge are on together for a period of overlap.

Phase-shift DC/DC converters afford particularly low switching losses as a result of zero voltage switching. In the phase shift principle, the phase shift serves as a duty cycle, a low phase shift corresponding to a high duty cycle and a high phase shift corresponding to a low duty cycle. The phase shift results in the two upper power switches or the two lower power switches of the full bridge being on together, and therefore in the primary side of the transformer being shorted, for some of the switched-on times.

In some embodiments, the control device may be configured to switch off the sixth power switch if a voltage is present on the transformer and to switch on the sixth power switch if no voltage is present on the transformer.

In operating situations in which no voltage is present on the transformer and therefore no energy is transmitted in the transformer either, the energy magnetically stored in the output coil of the DC/DC converter nevertheless continues to drive a flow of current that flows through the diodes of the bridge rectifier. The sixth power switch, which is on, affords a further current path, that is to say that the current now additionally flows through the sixth power switch instead of only through the diodes of the bridge rectifier. This firstly relieves the rectifier diodes of load, i.e. losses from the diodes decrease. Its resistive characteristic means that a MOSFET has a better forward response than a diode in the same power class. It is therefore possible to reduce semiconductor losses from the whole circuit. Furthermore, electrical losses are spread over more switches, which is generally desirable for cooling, since a better distribution of heat on the heat sink is achieved in this way.

The switching-on of the sixth power switch occurs in particular in the periods of time in which the primary side of the transformer is shorted as a result of an overlapping switched-on time of the two upper power switches or of the two lower power switches of the full bridge. The switching-off of the sixth power switch is therefore part of the normal switching cycle. The switching processes of the sixth power switch occur twice as often as those of the first four power switches, that is to say that it switches at twice the frequency.

In some embodiments, the DC/DC converter encompasses a common heat sink for the power modules that encompass the first to sixth power switches. In particular, the power module that provides the fifth and sixth power switches is thus also involved in cooling the other power modules. This achieves optimum cooling for all power switches given the simplest possible production of the DC/DC converter.

DC/DC converters of the phase-shift type are frequently implemented in a unidirectional form and therefore use a diode-based rectifier. However, it is also possible for the rectifier to be implemented in an active form by using power switches and thus for a bidirectional DC/DC converter of the phase-shift type to be provided.

In some embodiments, the DC/DC converter has, in particular, a rated power of more than 20 kW. For that reason, it may be expedient if the power switches installed in the DC/DC converter have a current carrying capacity of at least 100 A and/or a reverse withstand voltage of at least 100 V.

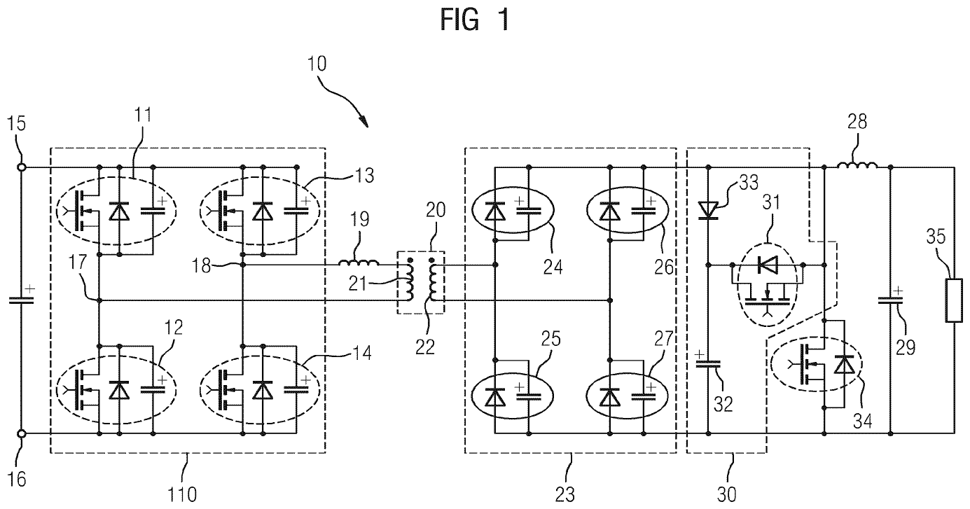

FIG. 1 shows an electrical circuit diagram of a DC/DC converter 10 of the phase-shift full-bridge (PSFB) type incorporating teachings of the present disclosure. The DC/DC converter 10 encompasses a full bridge 110 containing a first to a fourth MOSFET (metal oxide semiconductor field effect transistor) 11 . . . 14. The MOSFETs 11 . . . 14 in FIG. 1 are depicted together with their body diode and their parasitic output capacitance. In this embodiment, these additional parts are thus not actual separate parts.

The MOSFETs 11 . . . 14 in this arrangement form, in a known manner, two half-bridges connected in parallel, each of the half-bridges encompassing two of the MOSFETs 11 . . . 14 in a same-sense series circuit. The full bridge 110 has the external connections of the half-bridges connected to input connections 15, 16 for a DC voltage.

Connected between the midpoints 17, 18 of the half-bridges is a series circuit containing a resonant inductance 19 and the primary side 21 of a transformer 20. The secondary side 22 of the transformer 20 is in turn connected to a bridge rectifier 23. The bridge rectifier 23 encompasses four diodes 24 . . . 27, which are analogously joined together to form a full bridge. The diodes 24 . . . 27 in FIG. 1 are likewise depicted together with their parasitic capacitance, which is thus likewise not an actual separate part.

Connected to the output of the bridge rectifier, in series with a symbolic load 35, is an output inductance 28, which is customary for DC/DC converters of the phase-shift type. Furthermore, a smoothing capacitor 29 is connected in parallel with the output of the bridge rectifier, that is to say in parallel with the load 35.

Likewise connected to the output of the bridge rectifier is an overvoltage protection circuit 30. Said circuit encompasses a series circuit containing a protection capacitor 32 and a parallel circuit comprising a protection diode 33 and a fifth MOSFET 31. The protection diode 33 in this arrangement is designed such that, when an overvoltage occurs, it turns on and therefore limits the voltage to that of the protection capacitor 32. The duration of possible protection is limited by the charge of the protection capacitor 32; in the case of DC/DC converters of the phase-shift type, however, the occurrence and duration of the overvoltages are known and the protection capacitor 32 can be designed such that there is adequate protection. The fifth MOSFET 31 is used to discharge the protection capacitor 32 after a phase of overvoltage and is thus switched on in an appropriate period in order to effect discharge.

In some embodiments, which is not depicted in FIG. 1, the overvoltage protection circuit 30 does not encompass a protection diode 33. In this case, the function of protection is also undertaken by the fifth MOSFET 31, which, for this purpose, needs to be switched on as soon as an overvoltage occurs. Likewise connected to the output of the bridge rectifier and therefore in parallel with the overvoltage protection circuit 30 is a sixth MOSFET 34. The fifth and sixth MOSFETs 31, 34 in this arrangement are each depicted together with their body diode in FIG. 1.

It can be seen that the fifth and sixth MOSFETs 31, 34 are connected in the same sense and in series in the style of a half-bridge if they are not used and controlled as a typical power converter half-bridge in the circuit in FIG. 1 either. It is therefore advantageously possible to use, for the fifth and sixth MOSFETS, a power module in which two MOSFETs are connected up as a half-bridge. In the circuit shown in FIG. 1, both MOSFETs 31, 34 are used and neither of the switches is wasted. The power module that provides the fifth and sixth MOSFETs 31, 34 is connected to the heat sink for the DC/DC converter in the same way as the power modules that provide the first to fourth MOSFETs 11 . . . 14.

The DC/DC converter 10 encompasses a controller for the MOSFETS 11 . . . 14, 31, 34 that generates switch-on and switch-off signals for the MOSFETs 11 . . . 14, 31, 34 and relays said signals to the drivers. The MOSFETs 11 . . . 14 of the full bridge 17 in this arrangement are driven as phase-shift DC/DC converters. In simple inverters, the MOSFETs 11 . . . 14 disposed diagonally in relation to another in each case, that is to say firstly the pair of MOSFETs 11, 14 and secondly the pair of MOSFETs 12, 13, would be switched on and off together.

During phase-shift operation, the switching-on does not occur at the same time, however, but rather the switched-on periods of the switches of the two half-bridges are shifted in time with respect to one another, that is to say are subject to a phase shift. The magnitude of the phase shift defines the duty cycle of the converter, a large phase shift corresponding to a short duty cycle, and vice versa. The phase shift may be so substantial that both upper switches or both lower switches, that is to say MOSFETs 11, 13 or MOSFETs 12, 14, are on at the same time and short the primary side 21 of the transformer 20.

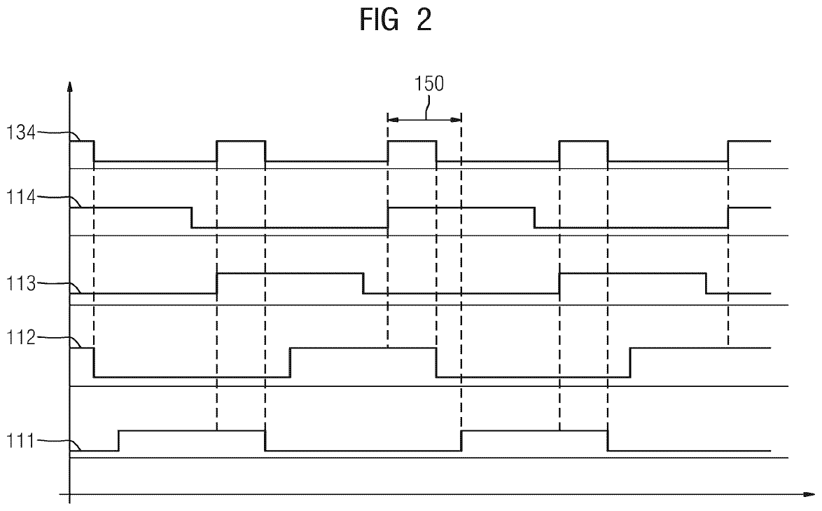

Details from a corresponding switching scheme are depicted in FIG. 2. The lines in FIG. 2 show the switching processes 111 . . . 114 of the first to fourth MOSFETs 11 . . . 14. The level close to the baseline denotes the switched-off state, while an increased response in the switching process 111 . . . 114 denotes the switched-on state. As can be seen, of the MOSFETs 11 . . . 14 that form a half-bridge in each case, that is to say the first and second MOSFETS 11, 12, on the one hand, and the third and fourth MOSFETs 13, 14, on the other hand, no more than one is on at any time, so as not to short the input voltage. A buffer period is observed in which both switches are off, so as also to avoid brief shorts that would arise otherwise, as the switches do not switch infinitely quickly.

Furthermore, the lines in FIG. 2 show that the diagonally disposed MOSFETs 11 . . . 14 do not switch on and off at the same time, as would be the case with a simple inverter. Rather, there is a phase shift 150, that is to say a time stagger. The magnitude of the stagger depends on the present operating situation, and so FIG. 2 only shows a possible and illustrative response. The phase shift 150 results in there being an overlap between the switched-on phases of the two upper MOSFETs 11, 13, likewise between the two lower MOSFETs 12, 14. During this overlap, the primary side 21 of the transformer 20 is shorted.

With respect to the sixth MOSFET 34, a distinction is drawn between two operating situations in a DC/DC converter 10 of the phase-shift type. In the first operating situation, an input voltage, which may be positive or negative, is present on the transformer 20. Energy is thus transmitted from the primary side of the DC/DC converter 10, that is to say the side of the first to fourth MOSFETs 11 . . . 14, to the secondary side of the DC/DC converter 10.

In the second operating situation, no voltage is present on the transformer. In this case, no energy is transmitted from the primary side to the secondary side. The energy stored by the output inductance 28 ensures a continued flow of current (in continuous mode) on to the output of the circuit, that is to say to the load 35. In this operating situation, the sixth MOSFET 34 is switched on. The current driven by the output inductance 28 therefore finds a further freewheeling path in the sixth MOSFET 34 in addition to the diodes 24 . . . 27 of the bridge rectifier.

FIG. 2 uses the switching response 134 to show how the sixth MOSFET 34 is switched. In the respective overlap phases that result from the overlap between the switched-on phases of the first and third MOSFETs 11, 13, on the one hand, and the second and fourth MOSFETs 12, 14, on the other hand, the sixth MOSFET 34 is switched on. It can be seen that two switched-on phases per switching cycle arise for the sixth MOSFET 34, and so it is operated at twice the frequency of the MOSFETS 11 . . . 14.

As the sixth MOSFET 34 and the bridge rectifier are connected in parallel, the electrical resistance in the freewheeling path decreases overall. As a result, the total electrical losses arising and therefore the transfer of heat to the heat sink decrease. Furthermore, the losses arising are spread over a greater number of elements, specifically not only the diodes 24 . . . 27 but now also the sixth MOSFET 34, resulting in an improved distribution of heat on the heat sink.

### REFERENCE SIGNS

10 DC/DC converter
11 . . . 14 MOSFET
15, 16 input connections
17, 18 midpoints of the half-bridges
19 resonant coil
20 transformer
21 primary side
22 secondary side
23 bridge rectifier
24 . . . 27 diodes
28 output inductance
29 smoothing capacitor
30 overvoltage protection circuit
31, 34 MOSFET
32 protection capacitor
33 diode
35 load
110 full bridge
111 . . . 114, 134 switching responses
150 phase shift

What is claimed is:

1. A DC/DC converter comprising:
four power switches forming a full bridge;
a resonant coil forming a series circuit with a primary side of a transformer, the series circuit connected between midpoints of two half-bridges of the full bridge;
a bridge rectifier connected to a secondary side of the transformer;
a control device for the four power switches;
an overvoltage protection circuit connected in parallel with an output of the bridge rectifier, the overvoltage protection circuit comprising a capacitor and a fifth power switch connected in series; and
a sixth power switch connected in parallel with the output of the bridge rectifier and in series with the fifth power switch.

2. The DC/DC converter as claimed in claim 1, wherein the control device operates the four power switches as a phase-shift converter by:
allowing a period of time to elapse between switching times of two of the power switches in a first half-bridge and switching times of the other two power switches of a second half-bridge; and
for at least some of the switching cycles, selecting the period of time such that both upper power switches are on together for a length of time.

3. The DC/DC converter as claimed in claim 1, in which the control device switches off the sixth power switch if a voltage is present on the transformer and switches on the sixth power switch if no voltage is present on the transformer.

4. The DC/DC converter as claimed in claim 1, further comprising a common heat sink for the power modules of the six power switches.

5. The DC/DC converter as claimed in claim 1, wherein a current carrying capacity of the six power switches is at least 100 A and/or in which the reverse withstand voltage of the power switches is at least 100 V.
